(19) United States
(12) Patent Application Publication
(10) Pub. No.: US 2005/0200590 A1
(43) Pub. Date: Sep. 15, 2005

(54) Display device, display-device driver circuit, and method of driving display device

(75) Inventor: Shuuji Kumekawa, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, Kawasaki (JP)

(21) Appl. No.: 11/067,702

(22) Filed: Mar. 1, 2005

(30) Foreign Application Priority Data
Mar. 10, 2004 (JP) 2004-067006

(51) Int. Cl. G09G 3/36

(52) U.S. Cl. 345/100

(57) ABSTRACT

In an embodiment of the present invention, a display-device driver circuit supplies a drive signal to a display panel based on image data transmitted from a display-control circuit. The display-device driver circuit has an error detection portion that detects whether there is an error in the image data, based on error-detection data corresponding to the image data transmitted from the display-control circuit; and an image data correction portion that correct the image data in which an error has been detected by the error detection portion.

### BACKGROUND OF THE INVENTION

1. Field of the Invention

The present invention relates to a driver circuit for use in a display-device driver circuit, to a method of driving a display device, and to a display device.

2. Description of the Related Art

The increasingly widespread use of liquid crystal display devices in computers, mobile phones, and other kinds of monitors is quite striking. One typical model of such a liquid crystal display device has a liquid crystal display (LCD) panel and a backlight unit arranged behind it. The LCD panel displays images by controlling the light passing through it from the backlight unit. An LCD panel has a number of image signal lines (source lines) and a number of scan lines (gate lines) arranged in a matrix. On the LCD panel, pixel is formed corresponding to each intersection of the image signal lines and the scan lines. The image-signal lines are driven by an image-signal line driver circuit (source driver IC); scan lines are driven by a scan-line driver circuit (gate driver IC). The image-signal line driver circuit and the scan-line driver circuit drive the LCD panel according to display signals and control signals from the display control circuit.

With the development of higher-resolution LCD panels and high-pixel camera functions, there has been much discussion about strategies for resolving problems such as the increase in signal lines and interference noise encountered in recent models of mobile phones and similar devices. One common way of dealing with these issues has been to reduce the number of signal lines by transmitting signals using high-speed serial differential transmission, and by reducing signal levels in order to lessen interference noise. However, with differential and small-amplitude serial transfer, there is a risk that the signal level of the data received will invert owing to electromagnetic noise.

The composition of a conventional type of image signal line driver circuit will now be explained, using FIG. 8. FIG. 8 is a block diagram showing the composition of an image signal line driver circuit 13. The image signal line driver circuit 13 comprises a data register 33, a data latch circuit 35, a level shift 36, a DAC (D/A converter) 37, and a timing controller 38. Input data 30 is digital pixel (RGB) data, inputted via the data register 33. The data register 33 stores the pixel (RGB) data. The timing controller 38 carries controls the data latch circuit 35, the level shift 36, and the DAC 37.

The data latch circuit 35 takes in pixel (RGB) data from the data register 33 at timings regulated by the timing controller 38. The level shift 36 converts the voltage of the pixel (RGB) data from logic voltage level to source voltage level. The DAC 37 converts digital signals to analogue signals and outputs source data output 39. The source data output 39 is inputted into each of the image signal lines as a drive signal according to a gradated voltage.

However, when high-speed serial data transmission is carried out at a small-amplitude signal level from the display control circuit of a microcomputer or similar device, there is an increased risk that the signal level of the data to be transmitted will invert owing to electromagnetic interference and so on. In particular, it can sometimes happen that the amplitude of the signal transmitted between the display control circuit and the driver circuit is reduced by some several hundred mV. The smaller the signal amplitude, the greater is the risk of signal level inversion. If signal levels invert, then data will be incorrectly recognized and an incorrect image will be displayed. For this reason, with the composition of the conventional image signal line driver circuit 13, there was no way of knowing whether the data contained an error until the image was displayed.

An LCD device equipped with a display controller function between the data-transmitting side (a CPU or similar) and the liquid crystal driver (the image signal line driver circuit) was disclosed in Japanese Unexamined Patent Application Publication No. 2002-72983. In this LCD display device, the display controller carries out error detection and requests a retransmission to the data transmitting. Then the data from the data-transmitting side is sent to the liquid crystal driver via the display controller. This LCD device needs the controller to carry out error control. Also, because error detection takes place at a predetermined periodic interval, there is a risk that any errors in the data received might not be detected immediately. As a consequence, one of the problems with conventional display devices has been that incorrect data is sometimes displayed.

It has now been discovered that, conventional display devices has been that incorrect data is sometimes displayed.

### SUMMARY OF THE INVENTION

An embodiment of the present invention is a display-device driver circuit supplies a drive signal to a display panel based on image data transmitted from a display-control circuit; the display-device driver circuit has an error detection portion that detects whether there is an error in the image data, based on error-detection data corresponding to the image data transmitted from the display-control circuit; and an image data correction portion that correct the image data in which an error has been detected by the error detection portion.

As a result of this even if there is an error in the data, it is possible to display pictures that do not show any display problems.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing the composition of a liquid crystal display device according to the present invention;

FIG. 2 is a block diagram showing the structure of an image signal line driver circuit according to a first embodiment of the present invention;

FIG. 3 shows data transfer using a high-speed serial interface;

FIG. 4 shows a format according to which data is transmitted and received between a display control circuit and an image signal line driver circuit in a display device according to the present invention;

FIG. 5 is a flowchart showing procedure for detecting an error and correcting data according to the first embodiment of the present invention;

FIG. 6 is a block diagram showing the composition of an image signal line driver circuit according to a second embodiment of the present invention;

FIG. 7 is a flowchart showing procedure for detecting an error and correcting data according to the second embodiment of the present invention; and

FIG. 8 is a block diagram showing the composition of a conventional type of image signal line driver circuit.

### DESCRIPTION OF THE PREFERRED EMBODIMENTS

### First Embodiment

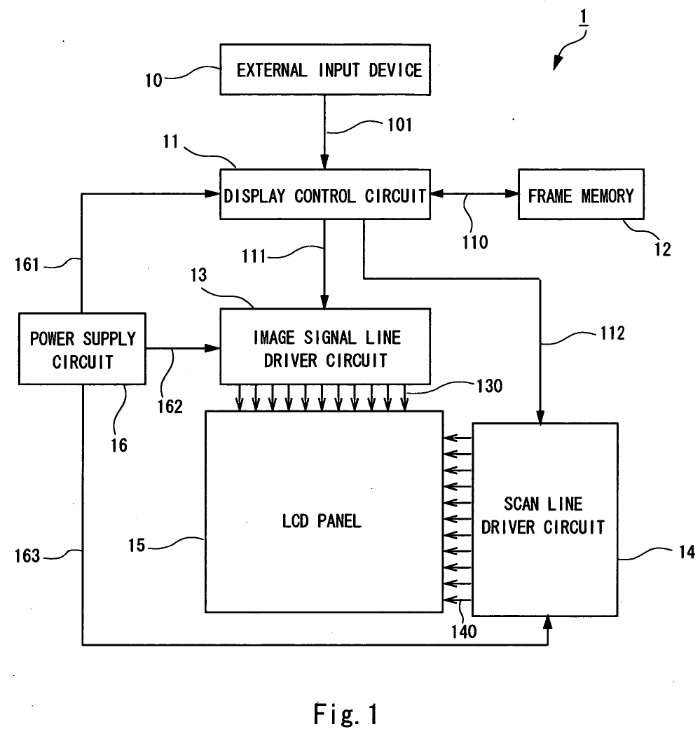

The overall composition of a liquid crystal display device according to a first embodiment of the present invention is described below using FIG. 1. FIG. 1 is a block diagram showing the composition of a liquid crystal display device structure suitable for use with the present invention. In FIG. 1, 1 is liquid crystal display device. In this diagram: 10 is an external input device, for example a mobile phone, PDA, TV tuner, video, personal computer and so on; 11 is a display control circuit; 12 is a frame memory; 13 is an image signal line driver circuit; 14 is a scan line driver circuit; 15 is a liquid crystal display panel; and 16 is a power supply circuit. The necessary electrical power voltage is supplied to the display control circuit 11, the image signal line driver circuit 13, and the scan line driver circuit 14 from the power supply circuit 16 via power supply lines 161, 162, and 163.

The external input device 10 inputs image data/control signal 111 into the display control circuit 11. The display control circuit 11 is a control circuit such as a microcomputer or ASIC, which transmits image data 110 to the frame memory 12. The frame memory 12, which is formed from a DRAM, SDRAM, DDR, or similar device, temporarily stores this transmitted image data. The display control circuit 11 processes the present image data by using the previous image data temporarily stored in frame memory 12, as will be explained below. The liquid crystal display panel 15 displays an image based on the processed image data.

Typically, the liquid crystal panel 15 has a display area made up of pixels arranged in a matrix pattern and a frame area that forms an edge around the display area. The liquid crystal panel 15 has an array substrate on which an array circuit forms and an opposing substrate; the liquid crystal is inserted between these two substrates. An active matrix type liquid crystal display panel has switching elements that control the input and output signals of each pixel. A common type of switching element is a TFT (Thin Film Transistor).

A color liquid crystal display device has an RGB color filter layer on the opposing substrate. Each pixel within the display area of the liquid crystal panel 15 displays one of the RGB colors. Of course, in black-and-white displays, the pixels display either black or white. A number of signal lines and scan lines are arranged in a matrix pattern within the display area on the array substrate. The signal lines and the scan lines cross each other roughly at right angles. And a TFT is disposed close to the each intersection between the signal lines and the scan lines. Pixels selected by a scan voltage inputted from scan driver circuit 14 apply an electric field to the liquid crystal according to the image display signal voltage inputted from the image signal driver circuit 13.

In order to activate the image signal line driver circuit 13 and the scan line driver circuit 14, the display control circuit 11 outputs image data/control signal 111 to the image signal line driver circuit 13, and a control signal 112 to the scan line driver circuit 14. The scan line driver circuit 14 converts the control signal into the scan voltage and outputs this scan voltage to the scan lines on the liquid crystal panel 15. Pixel lines, to which a gradated voltage is applied, are switched to the ‘selected’ state by the scan signal 140 from the scan line driver circuit 14. The image signal driver circuit 13 converts the image data corresponding to pixels of one horizontal line into a gradated voltage. The image signal line driver circuit 13 outputs driver signal 130 to the signal lines on the liquid crystal panel 15 according to the gradated voltage based on the control signal. This process is repeated for each line in turn. The gradated voltage corresponding to the image data of one frame is applied to pixels on the liquid crystal panel 15 and an image is displayed. It should be noted that the present invention may also be used with other types of liquid crystal display devices besides the one described above, as well as with organic and inorganic EL display devices and other types of display device.

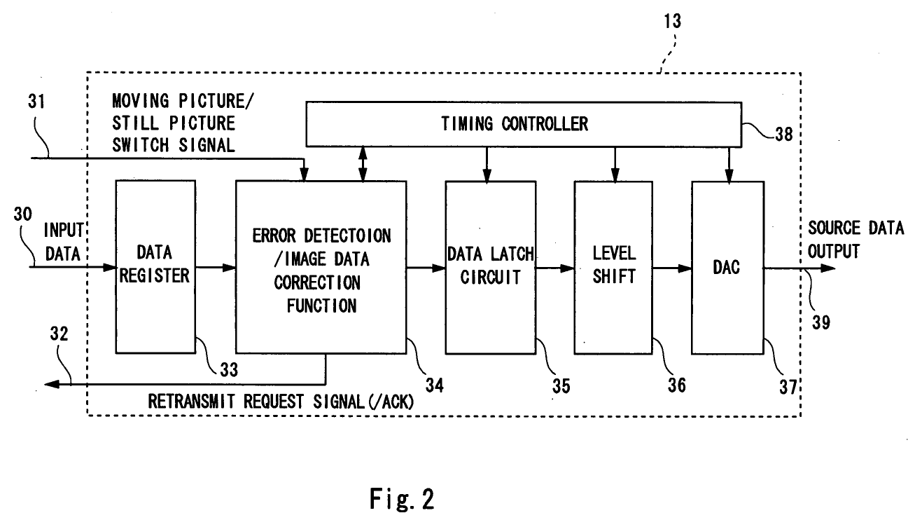

Next there follows an explanation of the display signal line driver circuit 13 according to the present embodiment, with reference to FIG. 2. FIG. 2 is a block diagram showing the composition of the image signal line driver circuit 13 according to the present embodiment.

The image signal line driver circuit 13 has a data register 33, an error detection/pixel data correction function 34, a data latch circuit 35, a level-shift 36, a DAC (D/A converter) 37, and a timing controller 38. Data register 33 stores pixel (RGB) data transmitted from the display control circuit 11. The timing controller 38 controls the data latch circuit 35, the level-shift 36, and the DAC 37. The error detection/pixel data correction function 34 has an error-detecting function that detects errors in the pixel (RGB) data and a pixel data correction function that corrects the pixel (RGB) data detected the errors. In other words, error detection/pixel data correction function 34 carries out correction of any data in which errors have been detected.

Input data 30 received from the display control circuit 11 is digital pixel (RGB) data, which is inputted into the data register 33. The error detection/pixel data correction function 34 detects any errors in the pixel (RGB) data inputted into data register 33. The error detection/pixel data correction function 34 further has a determination function that determines whether the pixel data is for use in a moving picture or a still image. The error detection/pixel data correction function 34 judges whether the input data 30 is intended for use in a moving picture or a still image by means of a moving picture/still picture switch signal 31. The moving picture/still picture switch signal 31 is inputted for example via a bus line provided for this purpose and connected to the display control circuit 11. In the case of a still picture, the error detection/pixel data correction function 34 sends a data retransmit request signal (/ACK) 32 to the transmitting side. The retransmit request signal (/ACK) 32 is transmitted for example via a bus line provided for this purpose connected to the display control circuit 11. In the case of a moving picture, the error detection/pixel data correction function 34 corrects the inputted data 30 using the pixel data correction function.

An explanation of what happens in the case of a still picture follows first. In pixels in whose corresponding pixel (RGB) data no error is detected, the pixel (RGB) data inputted into the data register 33 is written directly to the data latch circuit 35. The pixel (RGB) data in which an error is detected is not written to the data latch circuit 35. In this case, the pixel (RGB) data retransmitted following the retransmission request signal (/ACK) 32, pixel (RGB) data received a second time is written to the data latch circuit 35 instead. Of course, if an error is detected in the pixel (RGB) data received the second time, the retransmission request signal (/ACK) 32 is sent once again to the transmitting side. This process is repeated, and the pixel (RGB) data is written to the data latch circuit 35. The data latch circuit 35 receives pixel (RGB) data from the error detection/pixel data correction function 34 at timings designated by the timing controller 38.

Next, an explanation follows of what happens in the case with moving pictures. The error detection/pixel data correction function 34 has a pixel data correction register (not shown in the diagram). Pixel (RGB) data in which an error has been detected is not written to the pixel data correction register. In this case, pixel (RGB) data that has been corrected by the pixel data correction function is written to the pixel data correction register instead. In pixels in whose corresponding to pixel (RGB) data no error is detected, the pixel (RGB) data inputted into the data register 33 is written directly to the pixel data correction register. The data written to this pixel data correction register is then taken in by latch circuit 35.

The data latch circuit 35 takes in pixel (RGB) data from the pixel data correction register formed in the error detection/pixel data correction function 34 at timings designated by the timing controller 38. Because the data written to data latch circuit 35 has been retransmitted or corrected, the pixel (RGB) data is accurate and error free, or problem-free with image display. The level shift 36 converts the voltage level of the pixel (RGB) data from logic voltage level to source voltage level. The DAC 37 converts digital signals to analog signals and outputs the analog signals to the source data output 39. The source data output 39 is inputted into each of the data lines (image signal lines) as a driver signal based at a gradated voltage. As a result, there are no problems in data with image display.

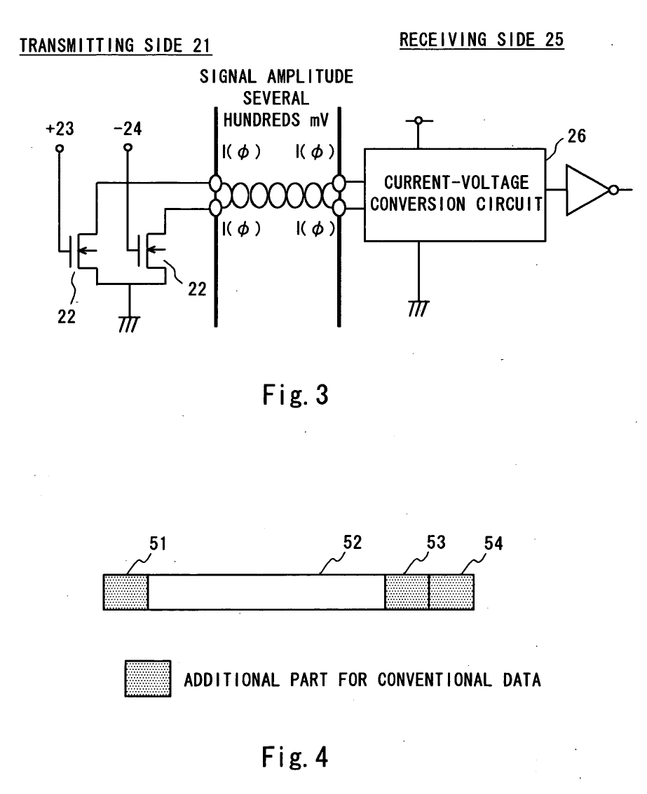

An explanation follows of the how input data 30 is inputted into the image signal line driver circuit 13, with reference to FIG. 3. FIG. 3 shows an example of data transfer using a high-speed serial data interface. This example shows a case in which a Mobile-CMADS (registered trademark) interface is used. Mobile-CMADS (registered trademark) is an abbreviation standing for Mobile-Current Mode Advanced Differential Signaling.

FIG. 3 shows how input data 30 is transmitted from the display control circuit of a microcomputer or similar device installed inside a liquid crystal display device to the image signal line driver circuit 13. In FIG. 3, the transmitting side 21 is the display control circuit 11, while the receiving side 25 is the image signal line driver circuit 13. An explanation follows of data transferred from transmitting side 21 to receiving side 25.

Transmitting side 21 comprises two N-ch open-drain transistors 22. The source side of these N-ch open-drain transistors 22 is connected to ground. The drain side is connected to the data-transmitting terminal. A positive voltage is applied to the drain side of the N-ch open-drain transistor 22 connected to the positive terminal 23. In the open-drain transistor 22 at the negative terminal 24, the drain side is supplied with a negative voltage. When data is transmitted, one of the two N-ch open-drain transistors 22 will become ON, and the other will become OFF.

Transmitting side 21 and receiving side 25 are connected by a differential cable that contains two signal lines. The differential cable has a positive signal line connected to the drain of the N-ch open drain register 22 at the positive terminal 23, and a negative signal line connected to the drain of the N-ch open drain register 22 at the negative terminal 24. The input data 30 is transmitted from transmitting side 21 to the receiving side 25 by means of differential serial transfer. A current-voltage conversion circuit 26 is mounted onto the receiving side 25. The current-voltage conversion circuit 26 converts the difference of current flowing through the positive and negative signal lines into voltage data and recognizes received data.

When transmitting high-level data from transmitting side 21 to receiving side 25, the N-ch open chain transistor at the positive terminal 23 on the transmitting side 21 turns ON. As a result, positive current flows through the positive signal line. At this time, the N-ch open drain transistor at the negative terminal 24 turns OFF. Because of this, the negative signal line becomes the ground, and no current flows. Current is drawn from a current source mounted in the current-voltage conversion circuit 26 on the receiving side 25, and the current-voltage conversion circuit 26 detects that the current source mounted on the positive signal line has been activated. In this way, receiving side 25 perceives that it has received high-level data.

Conversely, with low-level transfer, the N-ch open drain transistor 22 at the negative terminal 24 turns ON. As a result, a negative current flows through the negative signal line. Current is drawn from the current source mounted in the current-voltage conversion circuit 26 on the receiving side 25. At this time, the N-ch open drain transistor at the positive terminal 23 turns OFF. As a result, the positive signal line becomes ground, and no current flows. The current-voltage conversion circuit 26 on the receiving side 25 detects that the current source mounted on the negative signal line has been activated, and perceives that it has received low-level data. In this way, the receiving side 25, that is, the image signal line driver circuit 13 perceives that it has received high-level data when a positive current flows, and perceives that it has received low-level data when a negative current flows. In other words, the image signal driver circuit 13 recognizes data according to the current flowing between the transmitting side 21 and the receiving side 25.

A data transfer using a high-speed serial interface makes it possible to carry out high-speed serial data transfer at small-amplitude signal levels from the display control circuit 11 of a microcomputer or similar device. For example, it is possible to set the amplitude of the signals transmitted from the transmission side 21 to receiving side 25 to several hundred mV. However, when the amplitude is small, there is a risk that the signal level will invert The present embodiment has an error detection/pixel data correction function, as will be explained below. This makes it possible to transfer data without any display problems, even in circumstances where signal level inversion is liable to occur.

An explanation follows regarding the data that is transmitted from the transmitting side 21 to the receiving side 25, with reference to FIG. 4. FIG. 4 is a schematic representation of one example of a data format when the data is transmitted and received. In the example shown in FIG. 4, the input data 30 that is transmitted corresponds to a single pixel.

In a conventional data transmission format, the pixel (RGB) data 52 is transmitted alone, but in the present embodiment a start bit 51, an error detection bit 53 (parity bit), and an end bit 54 are transmitted at the same time as the pixel (RGB) data 52. The start bit 51, the error detection bit 53 (parity bit), and the end bit 54 are each appended to the pixel (RGB) data 52 corresponding to a pixel. Start bit 51, error detection bit 53 and end bit 54 can be generated by display control circuit 11, for example.

The start bit 51 and the end bit 54 are used to identify the location of data on which error detection is to be carried out. In other words, when start bit 51 is transmitted, the image signal line driver circuit 13 recognizes that transfer of data corresponding to one pixel has begun. The image signal line driver circuit 13 then processes any bits that come after start bit 51 as pixel (RGB) data. Likewise, when end bit 54 is transmitted, the image signal line driver circuit 13 recognizes that data transfer corresponding to one pixel has ended.

The error detection bit 53 is appended to the end of the pixel (RGB) data 52. The error detection/pixel data correction function 34 uses the error detection bit 53 to carry out data error detection. In concrete terms, error detection bit 53 is a parity bit, a bit inverts, for example, depending on whether the number of bits representing “1” in the pixel (RGB) data is odd or even. The error detection/pixel data correction function 34 detects errors by comparing this parity bit with the pixel (RGB) data. Of course, it is also possible to use other kinds of check besides a parity check, for example a hamming code check or CRC.

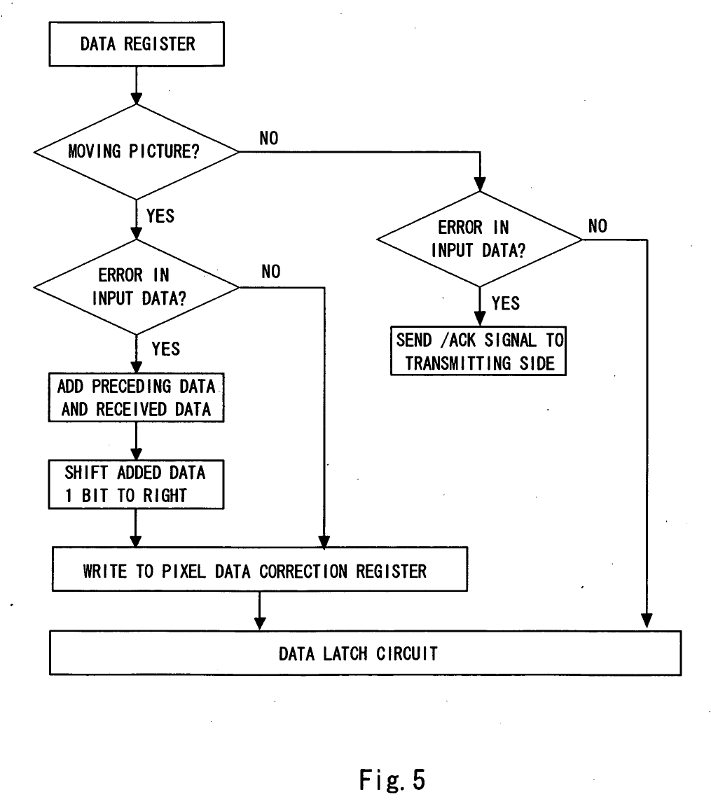

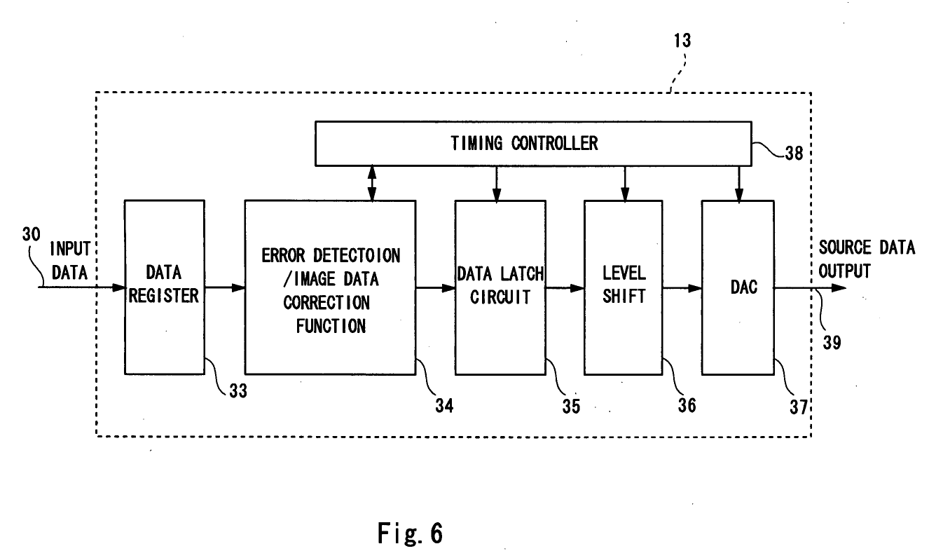

There now follows an explanation of how the error detection/pixel data correction function 34 works, using FIG. 5 for reference. FIG. 5 is a flow chart showing the process of error detection and pixel data correction 34. In other words, FIG. 5 illustrates the process carried out by error detection/pixel data correction function 34.

The error detection/pixel data correction function 34 determines whether the pixel (RGB) data inputted into the data register 33 is for use in a moving picture or not. In other words, it uses moving picture/still picture switch signal 31 to determine whether the pixel (RGB) data 52 is for use in a moving picture or a still picture. First an explanation is provided of a case in which the pixel (RGB) data inputted into data register 33 is for use in a moving picture.

In the case of a moving picture, error detection takes place as follows. Error detection is carried out using the error detection bit 53 (parity bit) as shown in FIG. 4. The error detection/pixel data correction function 34 carries out error detection on the pixel (RGB) data 52 inputted into the data register 33. If no error is detected in the pixel RGB data, then the pixel (RGB) data 52 is written directly to the pixel data register that forms part of error detection/pixel data correction function 34. If an error is detected in the pixel (RGB) data 52, then correction of the pixel (RGB) data 52 is carried out. The received data (the data in which an error has been detected) and the piece of data immediately preceding it are both used for the pixel (RGB) data correction. In the explanation that follows, the input data 30 in which an error was detected will be referred to as the received data, and the piece of data immediately before the received data will be referred to as the preceding data.

In correcting the pixel (RGB) data, the preceding data and the received data are added together and the added data is shifted one bit to the right. In other words, the mean value of the preceding data and the received data is treated as the correct data. Here, the preceding data corresponds to the pixel (RGB) data adjacent to the pixel corresponding to the received data in which an error was detected. Consequently, (the adjacent pixel data+the data in which an error was detected)/2 equals the correct data. The correct data is then written to the pixel (RGB) data correction register. Then the data latch circuit 35 takes in data from the pixel data correction register according to timings designated by the timing controller 38. In this way, the data which is problem-free data with image data is taken into the data latch circuit 35.

In the case of moving picture display, the display data is constantly being overwritten. According to the present embodiment, since the pixel data has been corrected, it is possible to display problem-free images without lowering the speed of data transfer per frame.

It should be noted that although according to the present embodiment the correct data is computed using the mean value of the received data and the preceding data, the options are not limited to this. It would also be possible, for example, to calculate the correct data by weighting the received data or the preceding data. It would also be possible to compute the correct data using the received data and the following, rather than the preceding, data.

Now an explanation is provided of what happens when the pixel (RGB) data inputted into data register 33 is for use not in a moving but in a still picture. When the moving picture/still picture switch signal 31 indicates that the pixel (RGB) data is for use in a still picture, error detection is carried out on the pixel (RGB) data in the same way as described above. If no error is detected in the still picture pixel (RGB) data, then the pixel (RGB) data 52 is taken into the data latch circuit 35. If an error is detected, on the other hand, then the error detection/pixel data correction function 34 sends a data retransmission request 32 to the transmitting side. The transmitting side recieves the data retransmission request 32 from the error detection/pixel data correction function 34, and retransmits the pixel (RGB) data 52. Error detection is then carried out in the same way on the retransmitted pixel (RGB) data. Then, if no error is detected in the retransmitted pixel (RGB) data, the data is taken in as it is by data latch circuit 35.

If an error is detected again in the retransmitted pixel (RGB) data, then the retransmission request signal is retransmitted again. And the process is repeated until there is no longer any error detected in the pixel (RGB) data. In the present embodiment, the data retransmission request is sent for any pixel (RGB) data in which an error has been detected, ensuring that accurate and error-free data is taken into the data latch circuit 35. As a result, it is possible to ensure that accurate and error-free images are displayed.

According to the present invention, the image signal line driver circuit 13 has an error detection function and an image data correction function. Consequently, it is possible to evaluate in the image signal line driver circuit 13 side whether or not there are any errors caused by electromagnetic interference etc in the data received from the display control circuit 11 of a microcomputer or similar device. Thanks to this, it is easy to detect errors in the data even before an image is displayed. Furthermore, as a result of the error detection process carried out on the pixel (RGB) data of every pixel, it is possible to ensure that accurate and problem-free images are always displayed. The present invention is particularly well suited to a differential and small-amplitude serial transfer, where there is a high risk that signals might become inverted at a small amplitude.

### Second Embodiment

An explanation follows of a second embodiment of the present invention, using FIG. 6 for reference. FIG. 6 is a block diagram showing the composition of an image signal line driver circuit. In the present embodiment, no distinction is made between moving pictures and still ones, and correction is carried out on all pixel (RGB) data in which an error has been detected. In the present embodiment, a description of compositions that are the same as those in the first embodiment will be omitted.

As in the first embodiment, the image signal line driver circuit 13 is a driver circuit for driving the image signal lines of an liquid crystal display. The transfer of data from the display control circuit 11, as well as the kind of data transferred, is as already described for the first embodiment above, and a full explanation is accordingly omitted here.

In the present embodiment, no distinction is made between moving pictures and still ones, and a correction is carried out on all pixel (RGB) data in which an error is detected. For this reason, the moving picture/still picture switch signal 31 is no longer necessary. In the error detection/pixel data correction function 34 no distinction is made between data for use in a moving picture and data for use in a still picture. An error detection is carried out within the error detection/pixel data correction function 34. As in the first embodiment described above, the error detection process is carried out using a parity bit. Error correction is carried out on all pixel (RGB) data in which an error has been detected, regardless of whether the data is for use in a moving or a still picture.

After this, as in the first embodiment, the source data output 39 is outputted to each of the image signal lines via the data latch circuit 35, the level shift 36, and the DAC 37. Because correction is carried out on all pixel (RGB) data in which an error has been detected according to the present embodiment, the moving picture/still picture switch signal 31 and the retransmission request signal 32 are no longer required. As a result, it is possible to reduce the number of bus lines and terminals, and the error detection/pixel data correction process can be carried out using a simple structure.

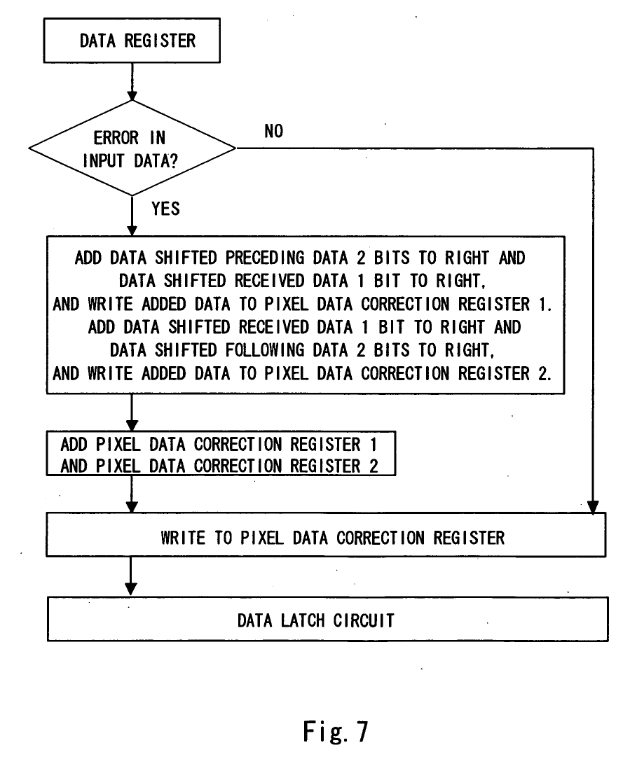

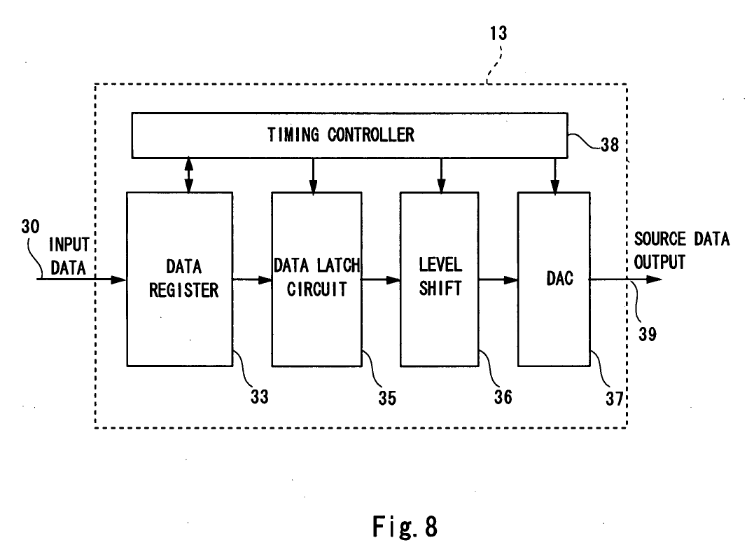

An explanation now follows of the error detection/pixel data correction process according to the present embodiment, using FIG. 7 as reference. FIG. 7 is a flow chart showing the error detection/pixel data correction process according to the present embodiment. According to the present embodiment, the image signal line driver circuit 13 has three pixel data correction registers, which will be referred to here as a first pixel data correction register, a second pixel data correction register, and a third pixel data correction register.

First, an error detection is carried out using a parity bit, in the same way as in the first embodiment. If no error is detected, then the data written to the data register 33 is written directly to the third pixel data correction register. On the other hand, if an error is detected, then the correction of the pixel (RGB) data is carried out by the pixel data correction function within image signal line driver circuit 13. In the present embodiment, unlike in the first embodiment, the pixel data correction uses not only the received data and the preceding data, but also the next piece of data following the received data. Here, the data in which an error has been detected will be referred to as the received data the data immediately before the data in which an error was detected will be referred to as the preceding data, and the data that comes immediately after the data in which the error has been detected will be referred to as the following data. The preceding data, received data, and the following data are three pieces of data corresponding to three pixels that are continuing in this same order.

The preceding data is shifted two bits to the right and the received data one bit to the right. These are then added together and the combined total is written to the first pixel correction register within the pixel data correction function. In other words, the mean value of the received data and the preceding data is written to the first pixel data correction register.

Next, an added data, which is added data shifted the received data one bit to right and data shifted the following data two bit to right together, is written to the second pixel data correction register. That is, the mean value of the received data and the preceding data is written to the second pixel data correction register. Here, the preceding data and the following data are the two bits of pixel (RGB) data corresponding to the pixels adjacent to the received data (in which the error was detected). That is to say, the received data in which the error was detected represents the pixel (RGB) data for the pixel that lies between the pixel corresponding to the preceding data and the pixel corresponding to the following data.

The added data, which is added the data written in the first pixel data correction register and the data written in the second pixel data correction register together, is written to the third pixel data correction register. The data written to the third pixel data correction register is then sent to the data latch circuit 35. In other words, in the present embodiment, the correction data is obtained by the formula (the received data+the preceding data+the received data+the following data)/4.

In the present embodiment the correct data was calculated using the received data, the preceding data, and the following data, the options are not limited to this. For example, it would also be possible to calculate the correct data using the received data and the preceding data alone, or on the received data and the following data alone. It would also be possible to calculate the correct data by weighting the received data, the preceding data, or the following data.

Furthermore, in the foregoing explanation the error detection bit was received appended to each pixel (RGB) data for one pixel, but the error detection bit does not have to correspond to each pixel (RGB) data for one pixel. For example, it would also be possible to append the error detection bit to the pixel (RGB) data for more than one pixel. It would also possible for the error detection bit to be appended to two or more pieces of image data derived from pixel (RGB) data for one pixel. Nor is the error detection bit limited to one single bit, but can consist of as many bits as desired.

The error detection/pixel data correction function 34 mentioned above can be implemented either by hardware configuration such as an integrated circuit, or by both hardware configuration and software stored thereto.

The foregoing explanations have used a liquid crystal display unit as an example, but the present invention may also be applied to an organic EL display device, an inorganic EL display device, or any other type of display device. In this case, the liquid crystal panel 15 should be exchanged for an organic EL display panel or similar device. Also, in the foregoing explanations, RGB data has been used an example of pixel data, but any other type of colors might just as well be used instead.

It is apparent that the present invention is not limited to the above embodiment, that may be modified and changed without departing from the scope and spirit of the invention.

1. A display-device driver circuit that supplies a drive signal to a display panel based on image data transmitted from a display-control circuit, comprising:
an error detection portion that detects whether there is an error in the image data, based on error-detection data corresponding to the image data transmitted from the display-control circuit; and
an image data correction portion that correct the image data in which an error has been detected by the error detection portion.

2. The display-device driver circuit according to claim 1, further comprising a moving picture display determing portion that determines whether the image data is for use in a moving picture display;
wherein the image data correction portion corrects the image data in which an error has been detected, when the image data is for use in a moving picture display.

3. The display-device driver circuit according to claim 2, wherein the display-device driver circuit sends a request to the display-control circuit asking for retransmission of the image data in which an error has been detected, when the image data is not for use in a moving picture display.

4. A display device comprising a display panel and a driver circuit that supplies a drive signal to the display panel based on image data transmitted from a display control circuit, wherein the driver circuit comprises:
an error detection portion that detects whether there is an error in the image data based on error-detection data corresponding to the image data transmitted from the display control circuit; and
an image data correction portion that corrects the image data in which an error has been detected by the error detection portion.

5. The display device according to claim 4, further comprising moving picture display determing portion that determines whether the image data is for use in a moving picture display, wherein the image data correction portion corrects the image data in which an error has been detected, when the image data is for use in a moving picture display.

6. The display device according to claim 5, wherein the display device sends a request to the display control circuit asking for retransmission of the image data in which an error has been detected, when the image data is not for use in a moving picture.

7. A method of driving a display device comprising a display control circuit that outputs a signal based on images displayed on a display panel and a driver circuit that provides a drive signal to the display panel based on signals from the display control circuit, wherein the method of driving a display device comprises:
transmitting image data and error-detection data corresponding to the image data from the display-control circuit to the driver circuit;
detecting whether the image data contains an error based on the error-detection data; and
correcting the image data when the image data contains an error.

8. The method of driving a display device according to claim 7, further comprising determining whether the image data is for use in a moving picture display, wherein the image data in which an error has been detected is corrected during the image data correcting, when the image data is for use in a moving picture display.

9. The method of driving a display device according to claim 8, wherein a request is sent to the display control circuit asking for retransmission of the image data in which an error has been detected, when the image data is not for use in a moving picture display.
